(19) United States
(12) Patent Application Publication
(10) Pub. No.: US 2009/0102957 A1
(43) Pub. Date: Apr. 23, 2009

(54) METHOD AND MEANS FOR VARYING THE CONTENT OF A DISPLAY

(75) Inventor: Andrew Peter Phelan, Bedfordshire (GB)

Correspondence Address: BROOKS KUSHMAN P.C., 1000 TOWN CENTER, TWENTY-SECOND FLOOR, SOUTHFIELD, MI, 48075, US

(73) Assignee: ACCREDIT INNOVATIONS LIMITED, Bedfordshire (GB)

(21) Appl. No.: 12/298,600

(22) PCT Filed: Apr. 27, 2007
(86) PCT No.: PCT/GB07/01574

§ 371 Date: Dec. 17, 2008

(30) Foreign Application Priority Data
Apr. 27, 2006 (GB) 0608309.1

(51) Int. Cl. H04N 5/222

(52) U.S. Cl. 348/333.01; 348/E05.022

(57) ABSTRACT

A method of varying the content of a physical display at a broadcast event between a direct viewer and a broadcast viewer, wherein the display comprises a direct viewer display image and a broadcast viewer display image, wherein the display displays one or more temporally interleaved data content instances, and wherein the display image for a broadcast viewer is synchronised to show one of said data content instances.

The present invention relates to a method of varying the content of a display between viewers, and a means to implement this method.

Displays or signboards are widely used to convey information to viewers, and their use is particularly important in the advertising industry, where such displays are used to advertise and promote goods and services. There are often distinct advantages in varying the information conveyed to different viewers by the display.

Methods have been developed to allow variation of the content of a display between viewers. Such a method is described in GB 2403367, which is herein incorporated by reference. The method described therein comprises the use of a multiple view display, comprising a display device such as an LCD and a parallax generating device such as a parallax barrier. GB 2405545, herein incorporated by reference, describes a method comprising the use of a directional display, such as an autostereoscopic display or duel view display, comprising an image display device having picture elements and a parallax optic comprising an array of colour filters. WO 2005/112476, herein incorporated by reference, describes a method that enables multiple viewers to view one of several video streams simultaneously displayed on a single video display, wherein viewers can only view with shutter viewing glasses synchronised to the video stream they are viewing. However, these methods are restricted to varying the display content of a physical display between direct viewers of the physical display itself.

Displays often appear in television broadcasts, and methods have also been developed to vary the content of a display between viewers observing a display via broadcast. US 2002/0144263, which is herein incorporated by reference, describes a method and apparatus for grouping targeted advertisements on an advertisement channel. GB 2305051, which is herein incorporated by reference, describes apparatus for automatic electronic replacement of a billboard in a video image, and GB 2 305 049, which is herein incorporated by reference describes an electronic billboard replacement system for use in a TV broadcast system. However, these methods are restricted to varying the content of a broadcast display between viewers of the broadcast.

The invention is set out in the claims. Because of the use of one or more temporally interleaved data content instances, the content of the display may be varied between a first and a second viewer, wherein the display comprises a physical display at a broadcast event, and the viewers include viewers who are local spectators in the presence of the physical display (direct viewers) and viewers who are watching a television broadcast of the event (broadcast viewers). The ability to vary the content of a display between a first and a second viewer has particular advantages in the field of advertising. For example, advertising can be restricted to commercially beneficial locations, companies providing advertising space can maximise advertising revenue by selling the same advertising space to more than one company, and advertising can be customised to particular viewers. In particular, the language in which the advertising appears can be customised to viewers in particular countries, and particular categories of advertising, for example advertisements for tobacco products, can be restricted in certain geographical regions.

Embodiments of the invention will now be described with reference to the Figures.

In the following description, a method of varying the content of a display between a first and a second viewer, and a means to carry out this method, are described. For the purposes of explanation, numerous specific details are set fourth to provide a thorough understanding of the present invention. It will be apparent to those skilled in the art that the present invention may be practiced without these specific details.

In a first embodiment of the present invention, the display comprises a physical, electronic signboard at a broadcast event. Preferably, the signboard comprises a plurality of Light Emitting Diodes (LED). The viewers of the signboard comprise viewers actually present at the broadcast event or local spectators in the presence of the physical signboard (termed the ‘direct viewers’) and viewers watching a broadcast of the event, or the television audience (termed the ‘broadcast viewers’).

The display images, or messages, appear on the signboard in the form of data content instances. Preferably, the display images comprise advertisements. Each display image may comprise a single, static image. For example, the display image may comprise an advertisement in the form of a single picture, illustration or photograph. In this case, the content of the data content instances will all be identical. Alternatively, each display image may comprise an animated, dynamic image. For example, the display image may comprise an advertisement in the form of a film or animation. In this case, the content of the data content instances may vary such that, when viewed sequentially, they produce the animated, dynamic image to the viewer.

A first display image is displayed for direct viewers, and a second display image is displayed for broadcast viewers. The data content instances for the broadcast viewer display image are temporally interleaved with the data content instances for the direct viewer display image.

In the first embodiment of the present invention, the signboard is recorded for broadcast as part of the overall image of the broadcast event using a camera which is operating at a frame rate high enough to produce the required number of frames per second. The camera shutter is synchronised with the data content instances corresponding to the display image for the broadcast viewer. The camera shutter speed is set such that the camera shutter is open for a duration that is contained within the display period of the image for the broadcast viewer.

Preferably, the data content instances corresponding to the first display image for direct viewers have a duration longer than the data content instances corresponding to the second display image for broadcast viewers. Preferably the data content instances for display to the broadcast viewers are displayed for periods of time too short to be registered by the human eye. Thus the data content instances for display to the broadcast viewers are not visible to the direct viewers. Experiments were performed to evaluate the direct viewer's perception of a display showing both a first and second image in time sequence. It was noted (based on a repetition rate 40 milliseconds) that when the display time of the second image fell below 10% of that of the first image then it became less easy to perceive the second image. When the display time of the second image fell below 1% of that of the first image then it became difficult to perceive the second image. When the display time of the second image fell below 0.1% of that of the first image then the second image was not perceived. Therefore, preferably, the data content instances for display to broadcast viewers are displayed for 10% or less of the frame time of the camera, more preferably 1% or less or more preferably 0.1% or less of the time frame of the camera.

Preferably, one display content instance for each display image is displayed within each frame recorded by the video camera. Thus the data content instance corresponding to a first display image for the broadcast viewers must be displayed at a frequency matched to the frame rate of the camera which is recording the event. However, as described above, the duration of the data content instances within each frame is variable.

In a first example of the first embodiment of the present invention, one display image is displayed for direct viewers and one display image is displayed for broadcast viewers. The display is recorded by a camera at a picture recording rate of 50 frames per second (50 Hz). Therefore, one frame is recorded by the camera every 20 milliseconds. The data content instances corresponding to the direct viewer display image are temporally interleaved with the data content instances corresponding to the broadcast viewer display image. The data content instances corresponding to a direct viewer display image are displayed for 19.8 milliseconds, and the data content instances for the broadcast viewer display images are displayed for 0.2 milliseconds.

A camera is synchronised to the time periods in which the data content instances corresponding to the display image for broadcast viewers are displayed. In the present embodiment, the camera is synchronised such that its shutter is only open when the data content instances for the broadcast viewers are displayed. In this way the broadcast viewer display image is synchronised by the broadcaster.

The images from the camera are then sent to an outgoing television feed signal and broadcast to the broadcast viewers.

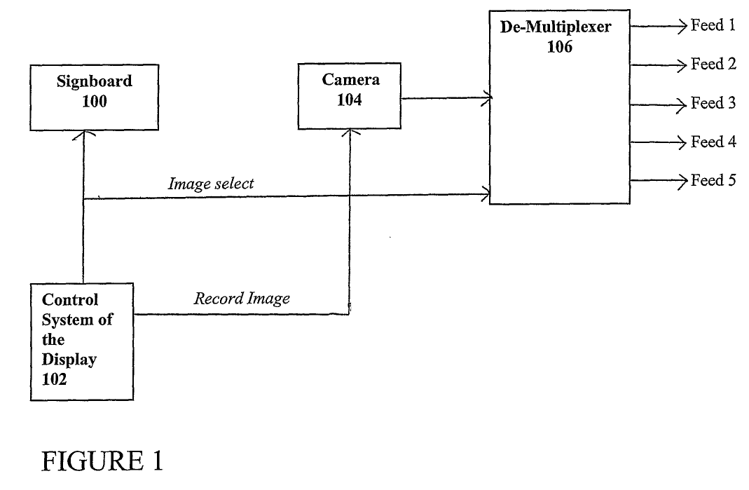

A second example of the first embodiment of the present invention will now be described with reference to FIG. 1, which shows a diagram of an embodiment of the method of the present invention. In this example, one display image is displayed on a signboard 100 for direct viewers and five different display images are displayed for broadcast viewers.

The data content instances for each of the five broadcast viewer display images are temporally interleaved with the data content instances for the one display image for the direct viewers. The display is recorded by a camera at a picture recording rate of 125 frames per second (125 Hz). Therefore, one frame is recorded by the camera 104 every 8 milliseconds. The data content instances corresponding to the 1 direct viewer display image are displayed for a total of 39.5 milliseconds, and the data content instances for each of the 5 broadcast viewer display images are each displayed for 100 microseconds. The data content instances corresponding to the broadcast viewer display images are spaced approximately evenly between the data content instances for the direct viewer display images. This smoothes the consistency of the display image perceived by the direct viewers at the broadcast event.

Table 1 shows the temporal interleaving of data content instances in the second example of the first embodiment, wherein the ‘first display image’ is for direct viewers, and wherein the second, third, fourth, fifth and sixth display images are for broadcast viewers.

TABLE 1
Temporal interleaving of data content instances

| Data content | Display image to which data | Time (milliseconds) of the |
|---|---|---|
| instance no. | content instances correspond | data content instance |
| 1 | First display image | 0-7.9 |
| 2 | Second display image | 7.9-8 |
| 3 | First display image | 8-15.9 |
| 4 | Third display image | 15.9-16 |
| 5 | First display image | 16-23.9 |
| 6 | Fourth display image | 23.9-24 |
| 7 | First display image | 25-31.9 |
| 8 | Fifth display image | 31.9-32 |
| 9 | First display image | 32-39.9 |
| 10 | Sixth display image | 39.9-40 |

Whilst the temporal allocation shown above has been chosen to maintain the smoothest image to the direct viewer, the images could be allocated differently to those shown in the figure above whilst still offering the same function.

Referring to FIG. 1, a signal from the Control System of the display 102 triggers the video camera 104 to record the data content instances corresponding to the display images for all broadcast viewers. The images are sent to a De-Multiplexer 106 which, controlled by signals from the Control System of the display, sends the data content instances corresponding to each display image to 5 outgoing video feeds at the normal frame rate. The video feeds may be viewed by different broadcast viewers. For example, different video feeds may be sent to different countries, such that broadcast viewers in these different countries view different display images.

This embodiment is capable of multiple message channels, has simple processing, which is important given that the requirement is often ‘live’, and automatically copes with objects moving across the signs.

As an alternative to broadcaster synchronisation of the broadcast viewer display image, the display image may be synchronised by a viewer wearable device. This device may comprise spectacles, and may synchronise with the display to show data content instances corresponding to the display image for the respective viewer.

Alternatively, separate video cameras can be utilised, each of which is synchronised to one of the display images for broadcast viewers. In this implementation each camera supplies a separate feed and there is no need for a De-Multiplexer.

In a third example of the first embodiment of the present invention, the data content instances corresponding to the broadcast viewer display image comprise ‘neutral space’. The neutral space preferably comprises a blue screen. The video camera is synchronised to the time periods in which the neutral space is displayed. Software is then used to overlay data content instances for alternative display images over the neutral space, based upon the known 3D spatial coordinates of the display, and information regarding the camera latitude, elevation and zoom.

In the third example, image processing software may be used to compare the static image of the event site and the dynamic image of the event, and to only superimpose the display image where the area on which the image is to be superimposed is the same in both the static image and the dynamic image. This prevents the display image being superimposed upon objects moving in front of the display screen.

Different display images may be superimposed onto the neutral space for different broadcast viewers. Even where more than one display image is to be superimposed onto the neutral space, only data content instances for the neutral space are interleaved with the data content instances for the display image for event viewers. Therefore, only two data content instances need be interleaved within each timeframe, and thus the speed required from the camera is less critical.

The above embodiments are described by way of example and not for the purposes of limitation. It will be clear to those skilled in the art that minor modifications can be made to the method of the present invention without significant changes to the operation described above. The display may comprises a physical display other than an electronic display, or may comprise electronic displays other than LED displays. More than one display image may be displayed for direct viewers, and more than one image may be displayed for broadcast viewers. The display images may comprise any image, and are not limited to advertisements. The use of other picture recording rates can be envisaged. The duration of the data content instances may be other than those detailed in the specific examples. More or less than one display content instance for each display image may be displayed within each video camera frame. Data content instances corresponding to the display images may be arranged relative to one another within each video camera frame in any number of ways. Other methods of synchronising the camera to particular data content instances can be envisaged. Neutral spaces other than blue screens may be used.

The present invention further comprises a means to implement the method of the present invention. This means may comprise a display, broadcast camera, broadcast system, image display device or viewer wearable device arranged to implement the method of the present invention. The manner in which the various components are selected or fabricated will be apparent to the skilled reader.

According to another aspect not in accordance with the above embodiment, there is provided a method of varying the display content of a display between viewers, wherein the display is a physical display at a broadcast event and the viewers include broadcast viewers, in which an image of the display received by each of a plurality of viewers shows one or more different data content instances. In accordance with this aspect, the display position of said display on a broadcast image may be identified and a data content instance overlaid at the display position. The display position may be identified by a spatial coordinate of the display, or by means of a position transmitter on the display.

According to another aspect not in accordance with the above embodiments, there is provided a method of varying the display content of a display between viewers, in which an image of the display received by each of a plurality of viewers shows one or more different data content instances, and wherein the display is directly viewable. This display may show one or more repeating, temporally interleaved data content instances and a viewer wearable device may synchronise with the display to show a corresponding data content instance. Preferably, the viewer wearable device comprises spectacles.

1.-13. (canceled)

14. A method of varying the content of a physical display at a broadcast event between a direct viewer and a broadcast viewer, wherein said display content comprises a direct viewer display image and a broadcast viewer display image, wherein said direct viewer display image and said broadcast viewer display image each comprise at least one data content instance, and wherein said data content instances are temporally interleaved.

15. The method of claim 14 wherein said broadcast event is recorded by a camera, and wherein said camera is synchronised to capture the data content instances of said broadcast viewer display image.

16. The method of claim 15, wherein said display content comprises two or more broadcast viewer display images, and said broadcast event is recorded by two or more cameras, wherein each camera is synchronised to capture the data content instances of at least one of said broadcast viewer display images.

17. The method of claim 15, comprising more than one broadcast viewer display image, wherein said camera records the data content instances of the more than one broadcast viewer display images, and wherein the data content instances corresponding to each broadcast viewer display image are sent to a separate outgoing video feed.

18. The method of claim 14 wherein a data content instance corresponding to a broadcast viewer display image comprises neutral space.

19. The method of claim 18 further comprising overlaying the neutral space with an alternative data content instance for the broadcast viewer.

20. The method of claim 19 wherein different alternative data content instances are overlaid for different broadcast viewers.

21. The method of claim 18 wherein the neutral space comprises a blue screen.

22. The method of claim 14 wherein the display is recorded for broadcast by a camera and wherein a data content instance corresponding to a display image for a broadcast viewer is displayed for 1% or less of the time frame of the camera.

23. The method of claim 22 wherein the data content instance corresponding to a display image for a broadcast viewer is displayed for 0.1% or less of the time frame of the camera.

24. A display, broadcast camera, broadcast system, image display device or viewer wearable device arranged to implement the method as described in claim 1.

25. A physical display arranged to display a display content, wherein said display content comprises a first display image which is visible to direct viewers of the display, and a second display image which is not visible to direct viewers of the display, wherein said first display image and said second display image each comprise at least one data content instance, wherein said physical display is configured to temporally interleave said data content instances.

26. The physical display of claim 25 wherein the data content instances of said second display image are displayed for 10% or less of the time for which the data content instances of the first display image are displayed.

27. A broadcast system comprising the physical display of claim 25, in addition to a camera synchronised to capture said data content instances of said second display image.

28. A camera configured to record a physical display, wherein said physical display comprises a display content, wherein said display content comprises a first display image and a second display image, said first display image and said second display image each comprise at least one data content instance, and said data content instances are temporally interleaved, wherein said camera is synchronised to record one or more data content instances corresponding to said second display image.

29. The camera of claim 28 wherein said camera comprises a shutter, and wherein said shutter is configured to open only for the duration of a data content instances corresponding to the second display image.

30. A television feed signal comprising one or more images of a physical display, wherein said physical display comprises a direct viewer display image and a broadcast viewer display image, said direct viewer display image and said broadcast viewer display image each comprise at least one data content instance, wherein said data content instances are temporally interleaved, and wherein said signal is composed such that it comprises only those images of the physical display incorporating data content instances corresponding to the broadcast viewer display image.

31. The television feed signal of claim 30 wherein said images are recorded by a camera which is synchronised to record one or more data content instances corresponding to the broadcast viewer display image.

32. A method of varying the display content of a physical display between two or more direct viewers of said physical display, wherein said display content comprises a first and a second display image, wherein each image comprises at least one data content instance, wherein said data content instances are temporally interleaved, wherein said second display image is only visible to a direct viewer wearing a viewer wearable device, and wherein said device is synchronised with the data content instances of said second display image.

33. A viewer wearable device for viewing a physical display, wherein said physical display comprises a display content, wherein said display content comprises a first and a second display image, wherein each image comprises at least one data content instance, wherein said data content instances are temporally interleaved, and wherein said viewer wearable device is configured to synchronise with, and allow the viewer to view, the data content instances corresponding to the second display image.
